(19) United States
(12) Patent Application Publication
(10) Pub. No.: US 2015/0179347 A1
(43) Pub. Date: Jun. 25, 2015

(54) BREAKDOWN INHIBITORS FOR ELECTROCHEMICAL CELLS

(71) Applicant: Refringent Technology LLC, Oshkosh, WI (US)

(72) Inventor: Charles P. Gibson, Oshkosh, WI (US)

(21) Appl. No.: 14/417,964

(22) PCT Filed: Jul. 29, 2013
(86) PCT No.: PCT/US13/52508

§ 371 Date: Jan. 28, 2015

Related U.S. Application Data
(60) Provisional application No. 61/677,627, filed on Jul. 31, 2012.

(51) Int. Cl. H01G 9/042; H01M 10/04; H01G 11/52; H01G 9/145; H01G 9/02; H01G 11/30; H01M 10/42; H01G 11/86

(52) U.S. Cl. CPC H01G 9/042; H01M 10/4235; H01M 10/049; H01G 11/86; H01G 9/145; H01G 9/02; H01G 9/0425; H01G 11/30; H01G 11/52

(57) ABSTRACT

An electrochemical cell includes a positive electrode, a negative electrode, an electrolyte, and optionally, a separator, wherein at least one of the positive electrode, negative electrode, electrolyte or the optional separator includes a breakdown inhibitor.

### FIELD

The present technology is generally related to breakdown inhibitors for use in electrochemical cells that contain a liquid or gel electrolyte in contact with a solid electrode. The breakdown inhibitors scavenge reactive chemical species that form when the electrochemical cell is charged to a high voltage.

### BACKGROUND

Electrochemical cells that contain a liquid or gel electrolyte in contact with a solid electrode are commonly used to store energy. Examples include batteries, electrochemical capacitors (which are sometimes called supercapacitors), and electrolytic capacitors. When operated at high voltage, these cells experience irreversible electrochemical reactions that cause physical damage to the cell. This degrades the performance of the cell, and, over time, may decrease capacitance, increase impedance, reduce hold time, and reduce cycle life.

Breakdown reactions are generally complex and poorly understood. Many studies of breakdown processes are aimed at determining what components of the cell are damaged, while most others focus on the chemical identity of the final products observed in the cell after breakdown. The main limitation of these studies is that they usually do not give enough information to identify reactive intermediates in the breakdown process, and this lack of knowledge makes it difficult to design breakdown inhibitors.

### SUMMARY

In one aspect, a breakdown inhibitor is provided that is configured to trap nucleophiles. Such breakdown inhibitors are to be used in the construction of an electrochemical cell. The breakdown inhibitor may be an inorganic substance that includes a transition metal. In one embodiment, the transition metal is copper.

In another aspect, a component of an electrochemical cell that contains a breakdown inhibitor is provided, and which is configured to trap nucleophiles.

Electrochemical cells including a breakdown inhibitor have improved electrochemical cell performance in comparison to similarly constructed electrochemical cells without the breakdown inhibitor. Examples of improved performance may include one or more of the following: higher operating voltage, lower capacitance fade, lower leakage current, longer cycle life, longer service life, lower impedance rise, or longer hold time. In one embodiment, the component is an electrode. In another embodiment, the component is an electrode coating. In another embodiment, the component is an electrolyte. In another embodiment, the component is a separator. In another embodiment, the component is a separator coating. In one embodiment, the component is a separator, and the breakdown inhibitor is chemically bonded to the separator. In another embodiment, the component is a separator, and the breakdown inhibitor is an active chemical site on the surface of a solid phase that is incorporated in the separator.

In another aspect, an electrochemical cell is provided that contains a component including a breakdown inhibitor that is configured to trap nucleophiles. In one embodiment, the electrochemical cell is a battery. In another embodiment, the electrochemical cell is an electrochemical capacitor. As used herein, the term “electrochemical capacitor” refers to any device wherein charge at at least one electrode is stored in one of the following ways: via double layer formation, via pseudocapacitance, or by a combination of double layer formation and pseudocapacitance. The term “pseudocapacitance” refers to certain Faradic charge storage processes that resemble non-Faradic processes in the sense that charge transfer is more or less proportional to voltage. In any of the above embodiments, the electrochemical cell is an electrochemical capacitor including an electrolyte that includes an organic nitrile or an organic carbonate solvent. In any of the above embodiments, the electrochemical capacitor includes acetonitrile (AN).

### BRIEF DESCRIPTION OF THE DRAWINGS

FIG. 1 is an illustration of a reaction of a carbanion with a cuprous cyanide to form the corresponding cuprate, according to one embodiment.

FIG. 2 illustrates a composite separator that contains a cuprous moiety bound to an insoluble ceramic component, wherein the coated ceramic particles are embedded in a porous polymeric matrix, according to one embodiment.

FIG. 3 is a scanning electron micrograph showing a cross-sectional view of a separator, as described in Example 3.

FIG. 4 shows a cyclic voltammogram for an electrochemical cell with a paper separator as compared to a cyclic voltammogram for an electrochemical cell with the separator of Example 3.

FIG. 5 is a portion of a voltammogram showing that the electrochemical cell containing the separator of Example 3 can be operated at higher voltage (−3.20 V) compared to the lower voltage (−2.7 V) for a similar electrochemical cell with a conventional separator.

FIG. 6 shows the results of a capacitance fade study conducted at 2.7 V and 65° C., which demonstrates that capacitance fade is lower for the device containing the separator of Example 3 as compared to the higher voltage fade of a control

FIG. 7 shows the results of an impedance rise study conducted at 2.7 V and 65° C., which demonstrates that that impedance rise is lower for the device containing the separator of Example 3 as compared to the higher impedance rise of a control.

FIG. 8 compares capacitance fade of an electrochemical cell containing the separator of Example 3 when operated at 3.0 V and 65° C. to capacitance fade of a similar electrochemical cell that contains a paper separator and which was operated at 2.7 V.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand process of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the term “liquid electrolyte” refers to an electrolyte having rheological properties that typify a liquid, gel, or melt at the operating temperature of the device.

As used herein, the term “solid electrode” refers to any electrode that forms a distinct phase boundary between the electrode and the electrolyte. While most electrodes of this type are true solids (i.e., have a defined rest state), certain gel electrodes, and even liquid electrodes (e.g., mercury electrodes) conform to this definition and are herein included as members of the class of solid electrodes as a matter of convenience.

As used herein, the term “negative electrode” refers to the electrode that has the more negative potential in an electrochemical cell when the cell is being charged. Under these conditions, electrochemical reduction (cathodic reactions) is favored at the negative electrode. The term “positive electrode” refers to the electrode that has the more positive potential in an electrochemical cell when the cell is being charged. Under these conditions, electrochemical oxidation (anodic reactions) is favored at the positive electrode.

As used herein, the term “inorganic substance” refers to a chemical substance comprising one or more transition metals and/or p-block metals. The term “cuprate” refers to an inorganic substance wherein an organic moiety is bonded to the inorganic substance, and the inorganic substance contains copper.

As used herein, the term “improved performance” means that an electrochemical cell containing the breakdown inhibitor has better performance than a similar cell that does not contain the breakdown inhibitor. Those skilled in the art understand that the performance of an electrochemical cell can be evaluated in many different ways depending on desired characteristics. Illustrative performance criteria that may be improved with the use of breakdown inhibitors include increased operating voltage, increased capacitance, increased cycle life, increased service life, higher operating temperature, larger voltage window, decreased capacitance fade, decreased leakage current, decreased impedance rise, decreased corrosion, and increased hold time, where hold time is defined as being the time required for the open circuit voltage of a charged cell to fall to 80% of the initial value.

As used herein: the term “breakdown reaction” refers to an irreversible electrochemical reaction in an electrochemical cell that occurs at high voltage and which causes, either directly or indirectly, damage to the electrochemical cell. As used herein, the term “high voltage” refers to a voltage above which one or more breakdown reactions occur. As used herein, the term “breakdown” refers to damage to the electrochemical cell caused by a breakdown reaction. As used herein the term “breakdown inhibitor” refers to a chemical substance that improves performance of an electrochemical cell by inhibiting breakdown. Breakdown inhibitors work by trapping chemical species that would otherwise cause damage in the cell, or by reacting to provide a physical barrier that protects cell components.

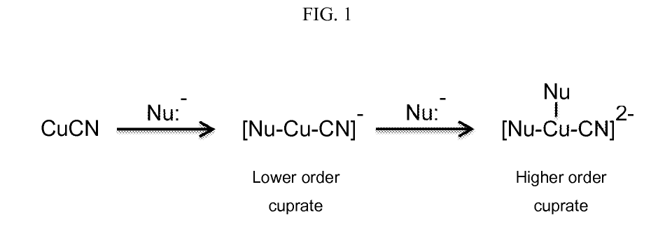

The present technology is generally related to breakdown inhibitors that are incorporated into the construction of an electrochemical cell and which are configured to trap nucleophiles that are formed as a product of, or intermediate of, breakdown reactions during electrochemical cell operation. In some embodiments, the breakdown inhibitor is an inorganic material that traps nucleophiles. Illustrative inorganic materials include, but are not limited to salts of transition metals or p-block metals, coordination compounds, ceramics containing transition or p-block metals, semiconductors containing transition or p-block metals, and organometallic complexes containing transition or p-block metals. Referring now the FIG. 1 a breakdown inhibitor of a cuprous salt is illustrated reacting with a nucleophile to form a cuprate, thus sequestering the nucleophile and preventing, or at least minimizing, electrochemical cell damage that may otherwise occur if the nucleophile were left unabated in the electrochemical cell.

In one embodidment, the breakdown inhibitor is included in an electrochemical cell. In one embodiment, the inhibitor is added to the electrolyte. In another embodiment, the inhibitor is chemically bonded to the container. In another embodiment, the inhibitor is applied to a separator. In a one embodiment, the inhibitor is bonded to a separator by depositing a solution comprising the inhibitor, binder, and solvent onto an electrode. In another embodiment, the inhibitor is applied to a separator.

Accordingly, in one embodiment, an electrochemical cell includes a positive electrode, a negative electrode, an electrolyte, and optionally, a separator. In such a cell, at least one of the electrodes, electrolyte or the optional separator includes any of the above breakdown inhibitors. In some embodiments, the breakdown inhibitor includes a transition metal or a p-block metal. The breakdown inhibitor may be a salt of transition metal or a p-block metal. Illustrative transition metals include, but are not limited to, Ni, Cu, Zn, Rh, Pd, Ag, Ir, Au and Pt. Illustrative p-block metals include, but are not limited to, Sn, Ga, Ge, In, Pb and Bi. Illustrative salts include, but are not limited to, cyanides, oxides, and halides (fluoride, chloride, bromide, or iodide). For example, some illustrative breakdown inhibitors include, but are not limited to, copper cyanide, copper oxide, copper chloride, palladium oxide, palladium chloride, tin oxide and tin chloride.

As described above, the breakdown inhibitor may be in any one or more components of the electrochemical cell. For example, the breakdown inhibitor may be associated with the positive electrode or the negative electrode. By associated with, it is meant that the breakdown inhibitor may be coated on the surface of an electrode either by itself or with a binder or adhesive, or the breakdown inhibitor may be intimately mixed with a precursor material to the electrode and then formed with the precursor material into an electrode. In a one embodiment, the breakdown inhibitor is bonded to an electrode by depositing a solution comprising the inhibitor, binder, and solvent onto an electrode.

The electrodes may be constructed from materials that conduct, store, or generate an electrical charge. For example, electrode materials may include, but are not limited to, activated carbon, hard carbon, graphite, transition or p-block metals, and transition or p-block metal oxides.

In addition to the electrode material, the electrode may be based upon a current collector. The electrodes are thus constructed by applying the electrode material, any needed binder, and, optionally a breakdown inhibitor to the current collector when forming the electrode. Illustrative current collectors include, but are not limited to carbon, aluminum, nickel, copper, zinc, zirconium, rhodium, palladium, silver, tin, tantalum, platinum, gold, stainless steel, and conducting metals oxides such as indium tin oxide.

As another example, the electrolyte may contain the breakdown inhibitor as either a particulate material or dissolved into the electrolyte.

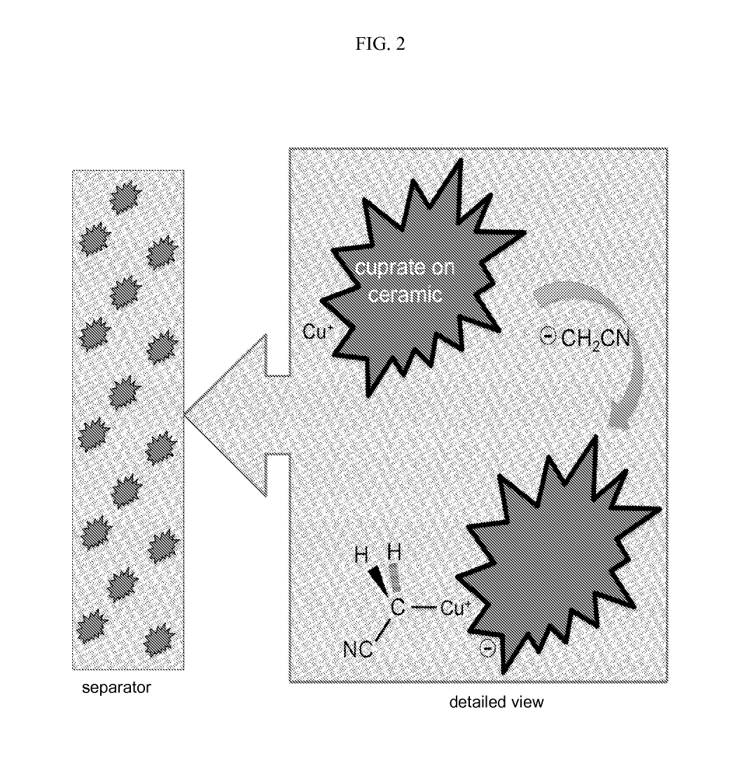

As yet another example, the separator may contain the breakdown inhibitor in much the same manner as the electrodes. The breakdown inhibitor may be included in the separator as a coating on the surface of the separator or it may be within the separator. Separators for electrochemical cells may include those made of porous polymers, ceramics, paper, glass fibers, and ceramic fibers. For example, the separator may include polyethylene, polypropylene, cellulose, carboxymethylcellulose (CMC), polytetrafluoroethylene (PTFE), polyvinylidene difluoride (PVdF), sintered glass, alumina fibers, and glass fibers. Thus, the breakdown inhibitor may be intimately mixed with the material to form the separator prior to separator formation so that the breakdown inhibitor is integrally formed within the separator. Alternatively, the breakdown inhibitor may be applied to, or coated onto, the surface of the separator either with a binder or without a binder. Illustrative examples of binders include, but are not limited to, PVdF, PTFE, CMC, and styrene butadiene rubber (SBR). In another embodiment, the breakdown inhibitor is bound to an insoluble component in the separator. For example, FIG. 2 illustrates a separator containing a cuprous moiety bound to an insoluble ceramic. This binding may be through a chemical bond, such as a coordinate covalent bond between an insoluble ceramic and the cuprous moiety wherein surface sites of the ceramic act as ligands with respect to the copper atom. Alternatively, a binder can be used to bond the inhibitor to the surface of the ceramic.

The electrochemical cells described above may include electrochemical capacitors, capacitive deionization cells, batteries, and electrolytic cells. As used herein, the term “electrochemical capacitor” refers to an electrochemical cell wherein the primary function is to store electrical energy, and wherein the primary mode of electrical energy storage at at least one electrode comprises electrical double layer formation at the interface of a solid electrode and liquid electrolyte, pseudocapacitance, or a combination of double layer formation and pseudocapacitance. As used herein, the term “capacitive deionization cell” refers to an electrochemical cell wherein the primary function is to remove ions from an electrolyte, and the ions are removed by formation of electrical double layers at the interface of a solid electrode and a liquid electrolyte. As used herein, the term “battery” refers to an electrochemical cell wherein the primary function is to store electrical energy, and wherein the primary mode of electrical energy storage comprises oxidation and/or reduction reactions that, on discharge, convert chemical energy to electrical energy. As used herein, the term “electrolytic cell” refers to an electrochemical cell wherein the primary function is to use electrical energy to affect a desired chemical transformation. In one embodiment, the electrochemical cell is an electrochemical capacitor.

The electrolytes of the electrochemical cells include a solvent and an optional salt for conductivity. The electrolyte may be a liquid electrolyte, a gel electrolyte, or a solid electrolyte. Illustrative solvents include, nitriles, carbonates, ethers, lactones, sulfones, silanes, and ionic liquids. Illustrative nitriles include, but are not limited to acetonitrile, propionitrile, butyronitrile, valeronitrile, caprylonitrile, heptanenitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile, 4-fluorophenylacetonitrile, methoxyacetonitrile, methoxy propionitrile, and ethoxy propionitrile. Illustrative carbonates include, but are not limited to, propylene carbonate, ethylene carbonate, ethyl methyl carbonate, diethyl carbonate, dimethyl carbonate, fluoroethylene carbonate, and vinyl ethylene carbonate. Illustrative ethers include, but are not limited to, tetrahydrofuran, ethylene glycol, propylene glycol, polyethylene glycol, polypropylene glycol, and fluorinated versions of the aforementioned ethers. Illustrative lactones include, but are not limited to, y-butyrolactone. Illustrative sulfones include, but are not limited to, diethyl sulfone, diethylsulfone, ethylmethyl sufone, and tetramethylene sulfone. Illustrative silanes include, but are not limited to, 2-[2-(2-methoxyethoxy)ethoxy]-ethoxy}trimethylsilane, bis{2-[2-(2-methoxyethoxy)ethoxy]ethoxy} dimethylsilane, {3-[2-(2-(2-methoxyethoxy)ethoxy)ethoxy]-propyl}trimethylsilane, {[2-(2-(2-methoxyethoxy)ethoxy)-ethoxy]-methyl}trimethylsilane. In one embodiment, the solvent of the electrolyte includes acetonitrile. Illustrative ionic liquids include, but are not limited to, 1-ethyl-3-methylimidazolium bis (trifluoromethylsulfonyl)imide, 1-ethyl-3-methylimidazolium trifluoromethanesulfonate, 1-butyl-1-methylpyrrolidinium bis (trifluoromethylsulfonyl)imide, 1-hexyl-3 -methylimidazolium hexafluorophosphate, 1-ethyl-3-methylimidazolium dicyanamide, and 11-methyl-3-octylimidazolium tetrafluoroborate.

Illustrative salts include, but are not limited to, LiClO₄, LiBF₄, LiAsF₆, LiPF₆, LiCF₃SO₃, Li(CF₃SO₂)₂N, Li(CF₃SO₂)₃C, LiN(SO₂C₂F₅)₂, lithium alkyl fluorophosphates, organoborate salts and mixtures thereof. In some embodiments, the salt may include organoborate salts such as lithium bis(chelato)borates including lithium bis(oxalato)borate and lithium difluoro oxalato borate, tetraethylammonium tetrafluoroborate, triethylmethylammonium tetrafluoroborate, tetraethylammonium tetraphenylborate, triethylmethylammonium tetraphenylborate, tetraethylammonium hexafluorophosphate, and triethylmethylammonium hexafluorophosphate.

In another aspect, a process is provided for making an electrochemical cell containing a breakdown inhibitor. The process may include providing a positive electrode and and a negative electrode, in either a paired arrangement or in a stacked formation of alternating positive and negative electrodes, the electrodes in either configuration being optionally separated by a separator. The electrodes are typically arranged in a container or other cell enclosure to hold the electrochemical cell. The container or other cell enclosure has an outer surface and an inner surface. The breakdown inhibitor may be associated with any one or more of the positive electrode, the negative electrode, the optional separator, or the inner surface the enclosure. The electrodes are then contacted with an electrolyte.

The process of making the electrochemical cell may include constructing the electrode. This may be accomplished by mixing the electrode material, whether it is an electroactive material or merely a conductive material, with the breakdown inhibitor to form an electrode precursor, and forming the electrode precursor material into an electrode. The mixing may include process such as stirring, blending, or milling. The electrode precursor may be an electroactive material which is configured to store electrical energy when charged, or the electrode precursor may be a condutive material which does not generate an electrical charge, but rather merely conducts the charge. Illustrative electrode materials include: activated carbon; hard carbon; graphite; transition or p-block metals such as lead, zinc, and copper; and transition or p-block metal oxides such as manganese oxide, cobalt oxide, cobalt nickel oxide, and lead oxide.

The process of making the electrochemical cell may include constructing the separator. This may be accomplished by mixing the separator material with the breakdown inhibitor, mixing the separator and the breakdown inhibitor together to form a separator precursor material, and forming the separator precursor material into a separator. Illustrative separator materials include, but are not limited to, include polyethylene, polypropylene, cellulose, carboxymethylcellulose (CMC), polytetrafluoroethylene (PTFE), polyvinylidene difluoride (PVdF), sintered glass, alumina fibers, and glass fibers.

In another aspect, another process is provided for making an electrochemical cell containing a breakdown inhibitor. The process may include providing a positive electrode and and a negative electrode, in either a paired arrangement or in a stacked formation of alternating positive and negative electrodes, the electrodes in either configuration being optionally separated by a separator. The electrodes are typically arranged in a container or other cell enclosure to hold the electrochemical cell. The container or other cell enclosure has an outer surface and an inner surface. A separate component may then be added to the electrochemical cell, the separate component including the breakdown inhibitor. The electrodes are then contacted with an electrolyte.

As used herein, the term “separate component” refers to a component that is separate from the electrode, electrolyte, separator, or container. The the separate component is not required for normal low-voltage operation of the electrochemical cell, but rather is a component that serves as a carrier for the breakdown inhibitor, which improves performance at high voltage. Illustrative examples of the separate component may be a porous material that contains the breakdown inhibitor, or a polymer containing the breakdown inhibitor.

The present invention, thus generally described, will be understood more readily by reference to the following examples, which are provided by way of illustration and are not intended to be limiting of the present invention.

### EXAMPLES

### Example 1

### Cuprous Salts

Sufficient cuprous cyanide is added to a 1M TEABF₄/AN electrolyte to provide a mixture that is about 1 mM in copper. The resulting mixture is used as an electrolyte in an electrochemical cell, where it is capable of trapping reactive nucleophiles formed as a product of breakdown reactions, as illustrated in FIG. 1.

### Example 2

### Separator with Bound Cuprous Ion

A jar is charged with: cuprous oxide (0.25 g), silica beads (5 g, −325 mesh), N-methylpyrrolidone (NMP; 10 ml), and a solution of 12.5% (w/w) polyvinylidenedifluoride (PVdF) dissolved in NMP (17.5 g). Zirconia grinding media is added and then the jar is sealed and placed on a jar mill where the mixture is milled for one hour. The suspension is decanted from the jar and spread onto a glass plate using a doctor blade with a 350 μm gap. The coated glass plate is then placed in a curing chamber where the solvent is evaporated to leave behind a thin porous ceramic/polymer film. The ceramic/polymer film is then lifted off the glass and dried in a vacuum chamber. The resulting film contains cuprous oxide dispersed in a ceramic/polymer matrix. The film may be used as a separator in an electrochemical capacitor, where the cuprous ion in the film is capable of trapping nucleophiles formed as a product of breakdown reactions, as illustrated in FIG. 2.

### Example 3

### Fabrication of a Ceramic/Polymer Composite Separator

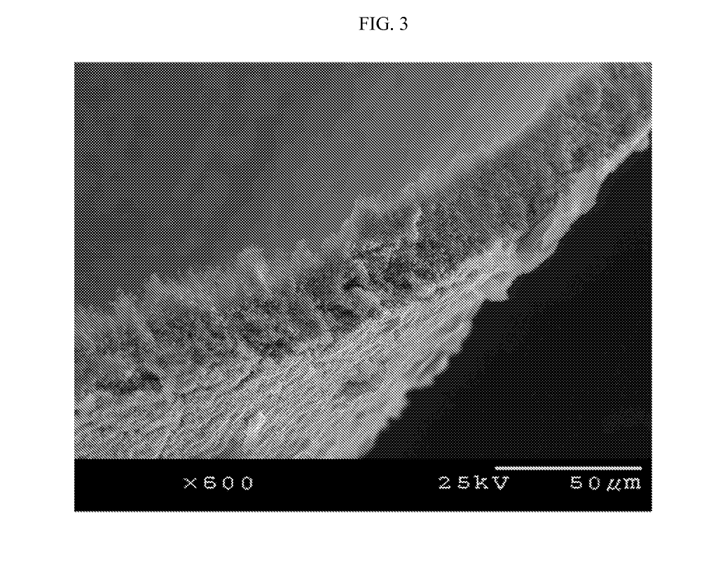

A jar is charged with: calcium copper titanate (CCTO; 7.50 g), NMP (10 ml), and a solution including 12.5% (w/w) PVdF dissolved in NMP (17.5 g). Zirconia grinding media is added and the jar is sealed and placed on a jar mill where the mixture is milled for one hour. The suspension is decanted from the jar and spread onto a glass plate using a doctor blade with a 350 μm gap. The coated glass plate is then placed in a curing chamber where the solvent is evaporated to leave behind a thin porous ceramic/polymer film. The ceramic/polymer film is then lifted off the glass and dried in a vacuum chamber. The film may be used as a separator in an electrochemical capacitor, where the cuprous ion in the film is capable of trapping nucleophiles formed as a product of breakdown reactions, as illustrated in FIG. 2. FIG. 3 is a scanning electron micrograph showing a cross sectional view of a separator of Example 3.

### Example 4

### Fabrication of an Electrode Containing a Cuprous Salt

The following components are mixed together: 85% w/w activated carbon (type YP-50 from Kurrary Chemical Company), 5% w/w carbon black (type SuperP from Timcal America, Inc.), 5% w/w PVdF, and 5% w/w copper(I) oxide. Sufficient NMP is added so that the resulting mixture has 27% solids. The resulting suspension is placed in a jar with zirconia grinding media. The jar is placed on a jar mill where the mixture is milled for one day. The suspension is decanted from the jar and spread onto an aluminum current collector using a doctor blade with a 280 μm gap. The coated current collector is then placed in a curing chamber where the solvent is evaporated. The resulting product may be used as an electrode in electrochemical capacitors, wherein the copper oxide is capable of trapping nucleophiles formed as a product of breakdown reactions.

### Example 5

### Fabrication of an Electrochemical Capacitor

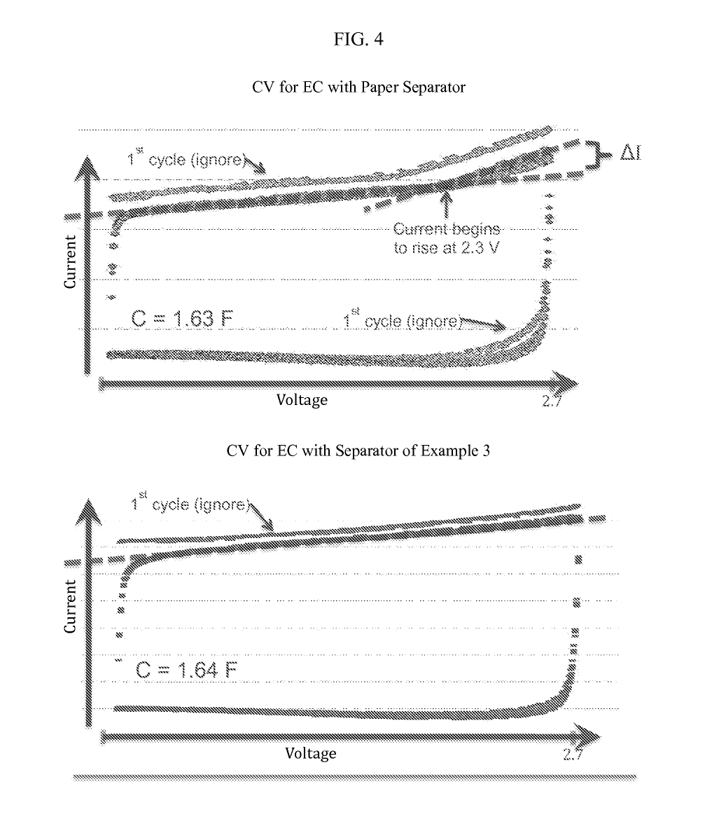

Components of the cell include: (1) electrodes based on an etched aluminum current collector coated with a film that includes activated carbon as the main ingredient, carbon black as a minor ingredient, and a minor amount of polytetrafluoroethylene (PTFE) binder; (2) 1M TEABF₄/AN electrolyte; and (3) a separator as described in Example 2 or 3. The electrodes were cut into 19 mm disks, and the separators were cut into 25 mm disks. The components were packaged in flat cell containers including aluminum structural elements (i.e., an aluminum case) with PTFE seals. For comparison, electrochemical capacitors that contained conventional paper separators, but were otherwise identical, were fabricated. These served as controls. Electrochemical testing showed that the electrochemical capacitors containing the separator with breakdown inhibitor showed better performance than the control electrochemical capacitors. FIGS. 4-8 illustrate the results of testing electrochemical capacitors containing a separator as described in Example 3 versus a control.

FIG. 4 shows the results of a cyclic voltammetry experiment conducted to a maximum voltage of 2.7 V. It can be seen that electrochemical breakdown reactions begin to occur at about 2.3 V for the electrochemical capacitor containing the paper separator (i.e., the control), as revealed by anomalous increase in current at 2.3 V. In contrast, an anomalous increase in current is not observed for the electrochemical capacitor containing the separator of Example 3. This demonstrates that the separator of Example 3 inhibits breakdown reactions.

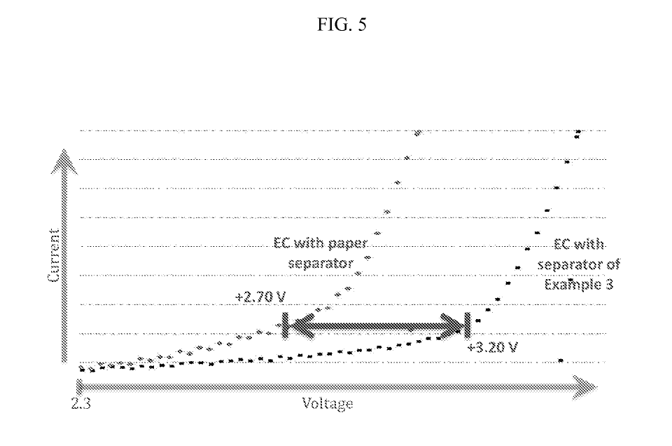

FIG. 5 is a graph of the results of a linear sweep voltammetry experiment for an electrochemical capacitor with a paper separator (i.e., control) and an electrochemical capacitor with a separator of Example 3. Although breakdown reactions for the control begin at 2.3 V, it is to be understood that cells of this type may be operated at 2.7 V, because damage caused by breakdown reactions is relatively minor when operated between 2.3 and about 2.7 V. FIG. 5 shows that the operating voltage can be increased to 3.2 V for the device with the separator of Example 3.

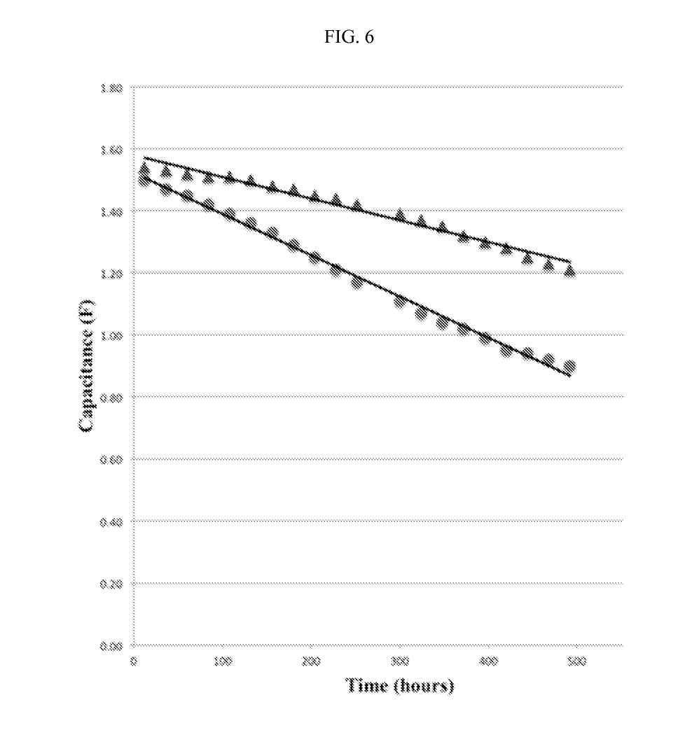

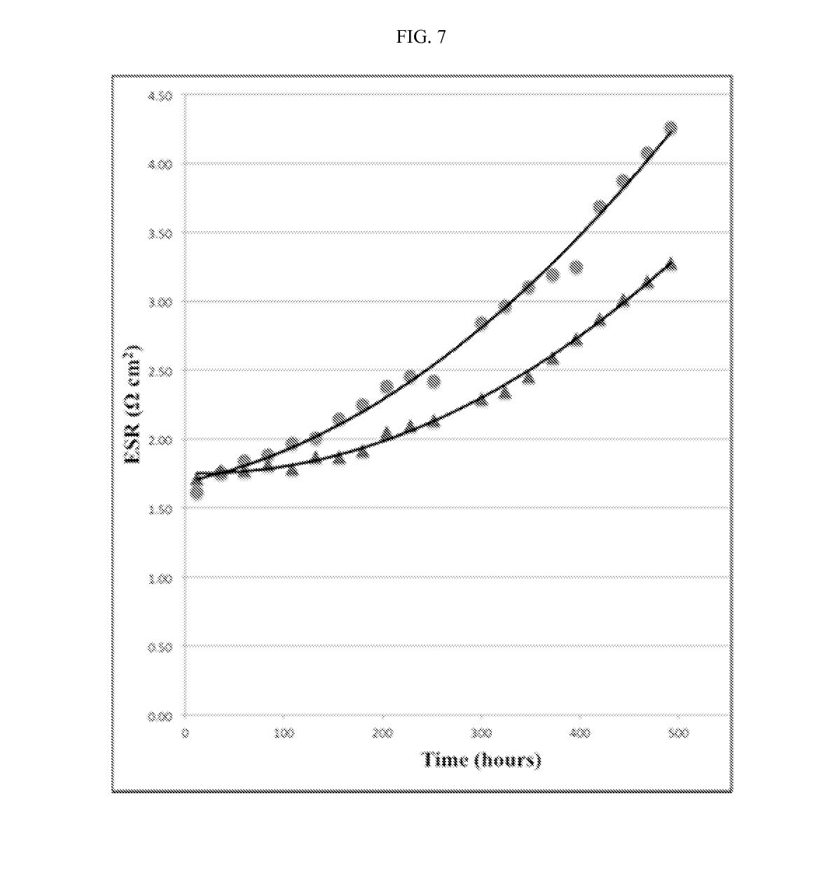

FIG. 6 illustrates that the capacitance fade is lower for the electrochemical capacitor with the separator of Example 3 (triangles) than for the electrochemical capacitor with a paper separator (dots). FIG. 7 shows that the impedance rise is lower for the electrochemical capacitor with the separator of Example 3 (triangles) than for the electrochemical capacitor with the paper separator (dots).

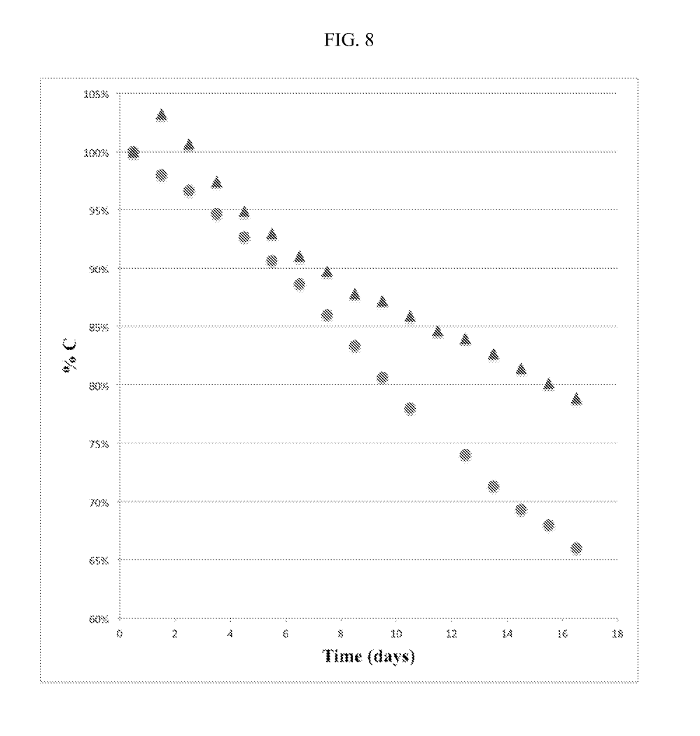

For FIG. 8, the electrochemical capacitor with the separator of Example 3 was operated at 3.0 V (triangles) while the electrochemical capacitor with a conventional separator was operated at 2.7 V. Despite the higher voltage, the capacitance fade of the electrochemical capacitor with the separator of Example 3 was less than that of the electrochemical capacitor with the conventional separator.

### Example 6

### Postmortem Examination of Electrochemical Capacitors

Two electrochemical capacitors were constructed as described in Example 5, except that stainless-steel flat cell containers were used. The cells were charged to high voltage (3.3 V). Afterwards, the cells were disassembled and examined for evidence of damage. In the case of the electrochemical capacitor with the paper separator, a significant amount of brown residue, an electrolyte decomposition product, was observed. In contrast, there was very little brown residue in the electrochemical capacitor that had contained the separator with the breakdown inhibitor. Also, the cell that had contained the paper separator showed more damage at the positive electrode compared to the electrochemical capacitor that had contained the separator with the breakdown inhibitor. These observations confirm that separator that contained the breakdown inhibitor protected the electrochemical capacitor against damage caused by breakdown reactions.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent processes and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular processes, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. An electrochemical cell comprising a positive electrode, a negative electrode, an electrolyte, and optionally, a separator, wherein at least one of the electrodes, electrolyte or the optional separator comprises a breakdown inhibitor.

2. The electrochemical cell of claim 1, wherein the breakdown inhibitor comprises an inorganic material comprising a transition metal or a p-block metal.

3. The electrochemical cell of claim 2, wherein the metal is a member of the group Ni, Cu, Zn, Rh, Pd, Ag, Ir, Pt, Ga, Ge, In, Sn, Pb, or Bi.

4. The electrochemical cell of claim 2, wherein the inorganic material comprises a salt of transition metal or a p-block metal.

5. The electrochemical cell of claim 4, wherein the metal of the metal salt comprises Ni, Cu, Zn, Rh, Pd, Ag, Ir, Pt, Ga, Ge, In, Sn, Pb, or Bi.

6. The electrochemical cell of claim 1, wherein the breakdown inhibitor comprises copper cyanide, copper oxide, copper chloride, palladium oxide, palladium chloride, tin oxide, tin chloride, calcium copper titanium oxide, or calcium(strontium) copper oxide.

7. The electrochemical cell of claim 1, wherein at least the positive electrode comprises the breakdown inhibitor.

8. The electrochemical cell of claim 1, wherein at least the negative electrode comprises the breakdown inhibitor.

9. The electrochemical cell of claim 1, wherein at least the electrolyte comprises the breakdown inhibitor.

10. The electrochemical cell of claim 1 further comprising the separator comprising the breakdown inhibitor.

11. (canceled)

12. The electrochemical cell of claim 1 which exhibits at least one of increased operating voltage, increased cycle life, increased service life, decreased capacitance fade, increased operating temperature, increased hold time, increased voltage window, decreased leakage current, decreased impedance rise, or decreased corrosion in comparison to a similarly constructed electrochemical cell without the breakdown inhibitor.

13. The electrochemical cell of claim 1 which is an electrochemical capacitor, a capacitive deionization cell, a battery, or an electrolytic cell.

14. The electrochemical cell of claim 1, wherein the electrolyte comprises acetonitrilea.

15. (canceled)

16. The electrochemical cell of claim 1 further comprising a separate compenent comprising the breakdown inhibitor.

17. The electrochemical cell of claim 1 further comprising a separate compenent comprising a second breakdown inhibitor.

18. The electrochemical cell of claim 1 which is an electrochemical capacitor.

19. A process for making an electrochemical cell, the process comprising:
providing a positive electrode and and a negative electrode, optionally separated by a separator;
packaging the electrodes and optional separator into a container, the container comprising an inner surface and an outer surface;
contacting the positive electrode and negative electrode with an electrolyte; and
wherein at least one of the positive electrode, negative electrode, optional separator, or inner surface of the container comprises a breakdown inhibitor.

20. The process of claim 19, wherein the electrode is constructed by mixing an electroactive material with the breakdown inhibitor, milling the elecroactive material and the breakdown inhibitor together to form an electrode precursor material, and forming the electrode precursor material into an electrode.

21. The process of claim 19 further comprising providing a separator, wherein the separator is constructed by mixing a separator material with the breakdown inhibitor and forming the electrode precursor material into the postive electrode.

22. A process for making an electrochemical cell, the process comprising:
providing a positive electrode and and a negative electrode, optionally separated by a separator; and
contacting the positive electrode and negative electrode with an electrolyte; and
packaging the electrodes, electrolyte and optional separator into a container; and
adding a separate component that comprises a breakdown inhibitor.
